(19) United States
(12) Patent Application Publication
(10) Pub. No.: US 2022/0056554 A1
(43) Pub. Date: Feb. 24, 2022

(54) RECOVERY OF MATERIAL FROM WET INCINERATOR BOTTOM ASH

(71) Applicant: Sepro Mineral Systems Corp., Langley (CA)

(72) Inventors: Jonas BOEHNKE, Langley, British Columbia (CA); Andrew GILLIS, Langley, British Columbia (CA)

(21) Appl. No.: 17/415,542

(22) PCT Filed: Dec. 9, 2019
(86) PCT No.: PCT/CA2019/051773

§ 371 Date: Jun. 17, 2021

Related U.S. Application Data
(60) Provisional application No. 62/781,486, filed on Dec. 18, 2018.

(51) Int. Cl. C22B 7/02; B01D 21/00; B01D 21/28; B01D 21/26; C22B 7/00; F23G 5/44

(52) U.S. Cl. CPC C22B 7/02; B01D 21/0009; B01D 21/283; F23J 2900/01001; C22B 7/006; F23G 5/44; F23J 2700/001; B01D 21/262

(57) ABSTRACT

A method of facilitating wet recovery of high density material from input wet incinerator bottom ash is disclosed. The method involves receiving the input wet incinerator bottom ash at a first density separator, separating by density from the input wet incinerator bottom ash, by the first density separator, first high density wet incinerator bottom ash and first low density wet incinerator bottom ash, causing the first low density wet incinerator bottom ash to flow to a second density separator, and separating by density from the first low density wet incinerator bottom ash, by the second density separator, second high density wet incinerator bottom ash and second low density incinerator bottom ash. Systems and apparatuses are also disclosed.

### RELATED APPLICATION

This application claims the benefit of U.S. Provisional Application No. 62/781,486 entitled “RECOVERY OF MATERIAL FROM WET INCINERATOR BOTTOM ASH”, filed on Dec. 18, 2018, which is hereby incorporated by reference herein in its entirety.

### BACKGROUND

### 1. Field

Embodiments of this invention relate to recovery of material or metal from wet incinerator bottom ash and more particularly to wet recovery of high density material or metal from input wet incinerator bottom ash.

### 2. Description of Related Art

Incinerator bottom ash is the residue of municipal and/or industrial waste incineration whereby energy is produced in the form of heat or electricity and from which valuable material such as metals may be recovered and/or recycled. Some incinerator bottom ash processing facilities use processing and filtering to target the recovery of high density material or metals. However, such incinerator bottom ash processing facilities may be unable to recover various valuable high density material or metals from the incinerator bottom ash.

### SUMMARY

In accordance with various embodiments, there is provided a method of facilitating wet recovery of high density material from input wet incinerator bottom ash. The method involves receiving the input wet incinerator bottom ash at a first density separator, separating by density from the input wet incinerator bottom ash, by the first density separator, first high density wet incinerator bottom ash and first low density wet incinerator bottom ash, causing the first low density wet incinerator bottom ash to flow to a second density separator, and separating by density from the first low density wet incinerator bottom ash, by the second density separator, second high density wet incinerator bottom ash and second low density incinerator bottom ash.

The method may involve causing the first high density wet incinerator bottom ash to flow to a third density separator, and separating by density from the first high density wet incinerator bottom ash, by the third density separator, third high density wet incinerator bottom ash and third low density wet incinerator bottom ash.

The method may involve causing the second high density wet incinerator bottom ash to flow to a second high density wet incinerator bottom ash density separator for causing the second high density wet incinerator bottom ash density separator to separate contents of the second high density wet incinerator bottom ash by density.

The third density separator may act as the second high density wet incinerator bottom ash density separator and causing the second high density wet incinerator bottom ash to flow to the second high density wet incinerator bottom ash density separator may involve causing the second high density wet incinerator bottom ash to flow to the third density separator for causing the third density separator to separate the contents of the second high density wet incinerator bottom ash by density.

The method may involve causing the third low density wet incinerator bottom ash to flow to a third low density wet incinerator bottom ash density separator for causing the third low density wet incinerator bottom ash density separator to separate contents of the third low density wet incinerator bottom ash by density.

The second density separator may act as the third low density wet incinerator bottom ash density separator and causing the third low density wet incinerator bottom ash to flow to the third low density wet incinerator bottom ash density separator may involve causing the third low density wet incinerator bottom ash to flow to the second density separator for causing the second density separator to separate the contents of the third low density wet incinerator bottom ash by density.

The first density separator may act as the third low density wet incinerator bottom ash density separator and causing the third low density wet incinerator bottom ash to flow to the third low density wet incinerator bottom ash density separator may involve causing the third low density wet incinerator bottom ash to flow to the first density separator for causing the first density separator to separate the contents of the third low density wet incinerator bottom ash by density.

The method may involve causing the third high density wet incinerator bottom ash to flow to a dewaterer for causing the dewaterer to remove water and recover metals from the third high density wet incinerator bottom ash.

The first density separator may separate less efficiently than the third density separator separates such that a first inefficiency ratio of a flow rate of low density solids in the first high density wet incinerator bottom ash over a total flow rate of solids in the first high density wet incinerator bottom ash is greater than a third inefficiency ratio of a flow rate of low density solids in the third high density wet incinerator bottom ash over a total flow rate of solids in the third low density wet incinerator bottom ash.

The first inefficiency ratio may be at least 5 times the third inefficiency ratio.

The third density separator may include a shaking table and separating the third high density wet incinerator bottom ash and the third low density wet incinerator bottom ash from the first high density wet incinerator bottom ash may involve separating using the shaking table.

The first density separator may include a pinched sluice density separator and separating the first high density wet incinerator bottom ash and the first low density wet incinerator bottom ash from the input wet incinerator bottom ash may involve separating using the pinched sluice density separator.

The second density separator may include a centrifugal concentrator and separating the second high density wet incinerator bottom ash and the second low density wet incinerator bottom ash from the first low density wet incinerator bottom ash may involve separating using the centrifugal concentrator.

Receiving the input wet incinerator bottom ash may involve receiving the input wet incinerator bottom ash consisting of a suspension of fine incinerator bottom ash in liquid, the fine incinerator bottom ash consisting of particles having a maximum diameter of less than a threshold diameter of about 4 mm.

The method may involve generating the input wet incinerator bottom ash from source incinerator bottom ash.

The method may involve incinerating input material to generate the source incinerator bottom ash.

In accordance with various embodiments, there is provided a system for facilitating wet recovery of high density material from input wet incinerator bottom ash, the system including a first density separator configured to receive the input wet incinerator bottom ash and separate by density from the input wet incinerator bottom ash, first high density wet incinerator bottom ash and first low density wet incinerator bottom ash, a second density separator configured to receive the first low density wet incinerator bottom ash and to separate by density from the first low density wet incinerator bottom ash, second high density wet incinerator bottom ash and second low density wet incinerator bottom ash.

The system may include a third density separator configured to receive the first high density wet incinerator bottom ash and to separate by density from the first high density wet incinerator bottom ash, third high density wet incinerator bottom ash and third low density wet incinerator bottom ash.

The system may include a second high density wet incinerator bottom ash density separator configured to receive the second high density wet incinerator bottom ash and to separate contents of the second high density wet incinerator bottom ash by density.

The third density separator may act as the second high density wet incinerator bottom ash density separator and the third density separator may be configured to receive the second high density wet incinerator bottom ash and to separate contents of the second high density wet incinerator bottom ash by density.

The system may include a third low density wet incinerator bottom ash density separator configured to receive the third low density wet incinerator bottom ash and to separate contents of the third low density wet incinerator bottom ash by density.

The second density separator may act as the third low density wet incinerator bottom ash density separator and the second density separator may be configured to receive the third low density wet incinerator bottom ash and to separate the contents of the third low density wet incinerator bottom ash by density.

The first density separator may act as the third low density wet incinerator bottom ash density separator and the first density separator may be configured to receive the third low density wet incinerator bottom ash and to separate the contents of the third low density wet incinerator bottom ash by density.

The system may include a dewaterer configured to remove water and recover metals from the third high density wet incinerator bottom ash.

The first density separator may be configured to separate less efficiently than the third density separator separates such that a first inefficiency ratio of a flow rate of low density solids in the first high density wet incinerator bottom ash over a total flow rate of solids in the first high density wet incinerator bottom ash is greater than a third inefficiency ratio of a flow rate of low density solids in the third high density wet incinerator bottom ash over a total flow rate of solids in the third low density wet incinerator bottom ash.

The first inefficiency ratio may be at least 5 times the third inefficiency ratio.

The third density separator may include a shaking table.

The first density separator may include a pinched sluice density separator.

The second density separator may include a centrifugal concentrator.

The input wet incinerator bottom ash may consist of a suspension of fine incinerator bottom ash in liquid, the fine incinerator bottom ash consisting of particles having a maximum diameter of less than a threshold diameter of about 4 mm.

The system may include a wet incinerator bottom ash source configured to generate the input wet incinerator bottom ash from source incinerator bottom ash.

The system may include an incinerator configured to incinerate input material to generate the source incinerator bottom ash.

Other aspects and features of embodiments of the invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a schematic view of a system for facilitating wet recovery of high density material from input wet incinerator bottom ash, according to various embodiments;

FIG. 2 is a schematic view of a system for facilitating wet recovery of high density material from input wet incinerator bottom ash, according to various embodiments;

FIG. 3 is a schematic view of a system for facilitating wet recovery of high density material from input wet incinerator bottom ash, according to various embodiments; and

FIG. 4 is a schematic view of a system for facilitating wet recovery of high density material from input wet incinerator bottom ash, according to various embodiments;

### DETAILED DESCRIPTION

Municipal and/or industrial waste incineration may result in the production of energy in the form of heat or electricity and in the production of incinerator bottom ash from which valuable metals may be recovered and/or recycled. In various embodiments, incineration may be performed, for example, in grate, rotary kiln, and/or fluidized bed incinerators and the incinerator bottom ash produced from the incineration may be discharged through a wet cooling quench to produce a waste stream or wet incinerator bottom ash. The incinerator bottom ash may include inorganic (mineral or glassy) matter, organic (unburnt) matter, and metals, for example. The waste stream may be reduced in mass compared to the input municipal and/or industrial waste significantly (e.g., by more than 60%), which may result in a high metal concentration in the incinerator bottom ash (e.g., more than about 10% by mass).

In various embodiments, it may be desirable to recover high density material or solids such as metals from the incinerator bottom ash such that the recovered material may be sold and/or recycled. For example, municipal and industrial waste from modern societies may contain significant levels of valuable material, such as, for example, ferrous material, aluminum, copper, stainless steel, zinc, brass, gold, silver, platinum and other valuable precious and base metals. In various embodiments, there are provided herein embodiments for facilitating recovery of valuable metals in the fine particle sizes (e.g., 0-4 mm, 0-2 mm, and/or 0-1 mm), which may have been previously considered unrecoverable. In various embodiments, this may be particularly desirable in today's first world throw-away societies where increasing amounts of precious metals may be found in fine incinerator bottom ash, tracing back to mainly electronics and jewelry.

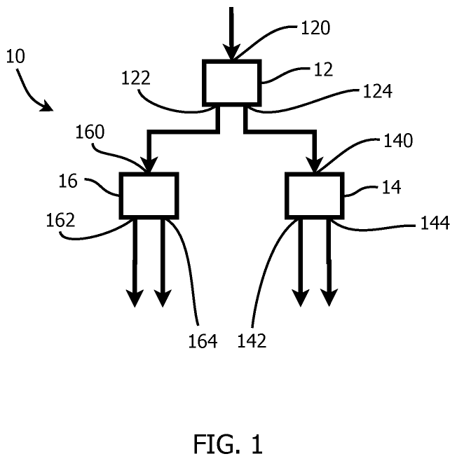

Referring to FIG. 1, there is shown a schematic representation of a system 10 for facilitating wet recovery of high density material from input wet incinerator bottom ash according to various embodiments. In various embodiments, the system 10 may be used to recover valuable high density material, such as metals, for example, from input wet incinerator bottom ash. In some embodiments, the system 10 shown in FIG. 1 and the description below may illustrate the workings of a general embodiment of the invention, which may be applied to other systems disclosed herein.

Referring to FIG. 1, the system 10 may include a first density separator 12 and a second density separator 14. The first density separator 12 may be configured to receive input wet incinerator bottom ash and to separate by density from the input wet incinerator bottom ash, first high density wet incinerator bottom ash and first low density wet incinerator bottom ash. In some embodiments, the wet incinerator bottom ash may be separated into streams. Referring to FIG. 1, the first density separator 12 may include an input 120 in fluid communication with a wet incinerator bottom ash source, for receiving the wet incinerator bottom ash. In some embodiments, the first density separator 12 may act as an initial density separator and may be configured to separate and/or process high volumes of wet incinerator bottom ash to allow one or more subsequent density separators to operate more efficiently and/or cost effectively on the output wet incinerator bottom ash.

Referring to FIG. 1, the first density separator 12 may include a high density wet stream output 122 and a low density wet stream output 124 for outputting the first high density wet incinerator bottom ash and first low density wet incinerator bottom ash, respectively, separated from the input wet incinerator bottom ash.

Referring still to FIG. 1, the output 124 of the first density separator 12 may be in fluid communication with an input 140 of the second density separator 14 such that the second density separator 14 is configured to receive the first low density wet incinerator bottom ash via the input 140.

The second density separator 14 may be configured to separate by density from the first low density wet incinerator bottom ash, second high density wet incinerator bottom ash and second low density wet incinerator bottom ash. Referring to FIG. 1, in various embodiments, the second density separator 14 may include a high density wet stream output 142 and a low density wet stream output 144 for outputting the second high density wet incinerator bottom ash and the second low density wet incinerator bottom ash, respectively.

In operation, input wet incinerator bottom ash may be received at the first density separator 12 and the first density separator 12 may separate by density from the input wet incinerator bottom ash, the first high density wet incinerator bottom ash and the first low density wet incinerator bottom ash. The first low density wet incinerator bottom ash may be caused to flow to the second density separator 14 via the output 124 of the first density separator 12 and the second density separator 14 may separate by density from the first low density wet incinerator bottom ash, the second high density wet incinerator bottom ash and the second low density wet incinerator bottom ash. In various embodiments, material included in the second high density wet incinerator bottom ash may be recovered and/or recycled. In some embodiments, the output 142 of the second density separator 14 may be in fluid communication with a dewaterer, for example, to remove water from the wet incinerator bottom ash and to leave the high density recovered material, which may in various embodiments include desirable metals.

In various embodiments, the first density separator 12 may be configured to remove a large portion of high density material from the input wet incinerator bottom ash, so that the second density separator 14 does not need to process much high density material. In some embodiments, this combination of the first and second density separators 12 and 14 may result in high throughput speed and high accuracy in separating high density material from the input wet incinerator bottom ash. In some embodiments, using two levels of density separation by using the first and second density separators 12 and 14 may facilitate greater throughput speed and higher accuracy for separating high density material or metals from the input wet incinerator bottom ash than would be possible where size separation and a single level of density separation may be used, for example.

In some embodiments, the first high density wet incinerator bottom ash flowing from the output 122 of the first density separator 12 shown in FIG. 1 may be dewatered and the high density material and/or metals therein may be recovered, and in such embodiments, a third density separator 16 as shown in FIG. 1 may be omitted from the system 10.

In other embodiments, further processing/separation may be performed on the first high density wet incinerator bottom ash. For example, referring to FIG. 1, in some embodiments, the system 10 may include the third density separator 16 configured to receive the first high density wet incinerator bottom ash and to separate by density from the first high density wet incinerator bottom ash, third high density wet incinerator bottom ash and third low density wet incinerator bottom ash. The third density separator 16 may include an input 160 in fluid communication with the output 122 of the first density separator. The third density separator 16 may include a high density wet stream output 162 and a low density wet stream output 164 for outputting the third high density wet incinerator bottom ash and the third low density wet incinerator bottom ash, respectively.

In operation, the first high density wet incinerator bottom ash may be caused to flow to the third density separator 16 via the output 122 of the first density separator 12, and the third density separator 16 may separate by density from the first high density wet incinerator bottom ash, the third high density wet incinerator bottom ash and the third low density wet incinerator bottom ash.

In various embodiments, material included in the third high density wet incinerator bottom ash may be recovered and/or recycled. In some embodiments, the output 162 of the third density separator 16 may be in fluid communication with a dewaterer, for example, for removing water from the incinerator bottom ash and keeping the high density recovered material.

In various embodiments, the first density separator 12 may be configured to remove a large portion of low density material, such that the third density separator 16 does not need to process much low density material. In various embodiments, this may result in high throughput, high efficiency or accuracy, and reduced costs for separating high density material from wet incinerator bottom ash.

In various embodiments, because the system 10 is configured to use multi-level density separation of wet incinerator bottom ash this may provide various benefits, for example, when compared to processing dry incinerator bottom ash and/or processing using a single level of density separation. For example, in some embodiments, because the system 10 is configured to process wet incinerator bottom ash, the system 10 may be used for fresh incinerator bottom ash and this may result in higher metal recovery rates, reduced dust emissions, avoidance of the aging period (4-6 weeks) and associated storage space for wet discharged incinerator bottom ash required before treatment, and/or other benefits. In some embodiments, the multi-level density separation facilitated by the system 10 may allow faster and more accurate separation of high density material and/or metals from input wet incinerator bottom ash.

In some embodiments, the system 10 may include aspects for further processing of the wet incinerator bottom ash. For example, in some embodiments, separated streams of the incinerator bottom ash may be further separated and/or fed back to one or more of the first, second and/or third density separators 12, 14, and 16. In various embodiments, this further processing and/or feedback may facilitate accurate and efficient separation of high density material or metals from the wet incinerator bottom ash.

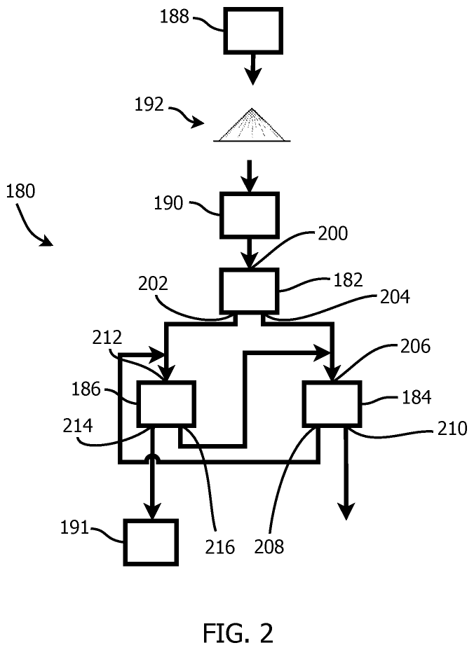

Referring now to FIG. 2, there is shown a system 180 for facilitating wet recovery of high density material from input wet incinerator bottom ash in accordance with various embodiments. The system 180 includes a first density separator 182, a second density separator 184 and a third density separator 186, which may function generally similarly to the first, second, and third density separators 12, 14, and 16 of the system 10 described above and shown in FIG. 1. In various embodiments, the system 180 may also include an incinerator 188, a wet incinerator bottom ash source 190, and a dewaterer 191.

In some embodiments, the incinerator 188 may be configured to incinerate input material, such as, municipal and/or industrial waste to generate source incinerator bottom ash 192. For example, in some embodiments, the incinerator 188 may include a grate, rotary kiln, and/or fluidized bed incinerator and the incinerator bottom ash produced from the incineration may be discharged through a wet cooling quench to produce a waste stream.

The wet incinerator bottom ash source 190 may be configured to generate input wet incinerator bottom ash from the source incinerator bottom ash 192. In some embodiments, the wet incinerator bottom ash source may include a wet attrition scrubber configured to receive the source incinerator bottom ash 192 and to break up conglomerated ash/lumps. The wet incinerator bottom ash source 190 may also include a screen or size classification device for separating fine incinerator bottom ash particles from the incinerator bottom ash and including only the fine incinerator bottom ash particles in the wet incinerator bottom ash provided to the first density separator 12. For example, in some embodiments, the screen may be configured to separate particles from the incinerator bottom ash by size, to generate a fine slag wet stream of incinerator bottom ash, which may act as the input wet incinerator bottom ash received by the first density separator 182. In various embodiments, some or all of the functionality provided by the wet incinerator bottom ash source 190 may be incorporated in the incinerator 188.

In some embodiments, the wet incinerator bottom ash source 190 may be configured to generate the input wet incinerator bottom ash such that it consists of a suspension of fine incinerator bottom ash in liquid or water, the fine incinerator bottom ash consisting of particles having a maximum diameter of less than a threshold diameter. The threshold diameter may be chosen such that particles having a smaller diameter than the threshold diameter may be particularly difficult to separate by density using dry separation. In some embodiments, the threshold diameter may be chosen by the efficiency of dry processing technologies (such as eddy current separators or optical sorters) at small particle sizes. In some embodiments, there may be a drop off in efficiency as particle size decreases, and 4 mm may be a point of unfavourable economics for dry metal recovery. Accordingly, in some embodiments, the threshold diameter may be about 4 mm. In some embodiments, the threshold diameter may be between about 2 mm and about 4 mm.

In various embodiments, the wet incinerator bottom ash source 190 may be configured to add water to the incinerator bottom ash such that the generated input wet incinerator bottom ash includes about 40% solids and 60% water by weight. In some embodiments, the solids included in the incinerator bottom ash may include 44% minerals, 37% slag, 15% metal, and 4% organics, for example. In some embodiments, the wet incinerator bottom ash source 190 may be configured to provide about 8 tonnes/hour (solids) of the input wet incinerator bottom ash, for example. In some embodiments, other flow rates of input wet incinerator bottom ash may be provided, such as, for example, higher flow rates of about 40 tonnes/hour (solids). In various embodiments, the system 180 may include a pump, a pumpbox or reservoir, and/or pipes for pumping the wet incinerator bottom ash from the wet incinerator bottom ash source 190 to the first density separator 182. For example, in some embodiments, the pump may be implemented as a peristaltic pump or centrifugal pump.

The first density separator 182 shown in FIG. 2 may be configured to receive the input incinerator bottom ash via an input 200 of the first density separator 182 in fluid communication with the wet incinerator bottom ash source 190. In some embodiments, the first density separator 182 may include a pinched sluice density separator. In such embodiments, receiving the input wet incinerator bottom ash may involve receiving the input wet incinerator bottom ash at a pinched sluice density separator input. In some embodiments, using a pinched sluice as the first density separator 182 may provide advantages, such as, for example, facilitating handling of high input flow rates by the system 180, allowing a widely variable selectivity ratio, which may be defined as a ratio of flow rate of solids in the high density wet incinerator bottom ash over flow rate of solids in the low density wet incinerator bottom ash, and/or working well with typical incinerator bottom ash mixed particle shapes, which may include balls, wires, etc., for example. The pinched sluice may be configured to receive and process a high flow rate, such as, for example, 8 tonnes/hour of solids, in some embodiments.

The first density separator 182 may be configured to separate by density from the input wet incinerator bottom ash, first high density wet incinerator bottom ash and first low density wet incinerator bottom ash. As discussed above, in some embodiments, the first density separator 182 may include a pinched sluice density separator and so separating the input wet incinerator bottom ash may involve the pinched sluice density separator separating the first high density wet incinerator bottom ash and the first low density wet incinerator bottom ash from the input wet incinerator bottom ash. In various embodiments, the first density separator 182 may be configured to output the first high density wet incinerator bottom ash from a high density wet stream output 202 of the first density separator 182 and to output the first low density wet incinerator bottom ash from a low density wet stream output 204 of the first density separator 182.

In some embodiments, the first density separator 182 may be configured to separate the first high density wet incinerator bottom ash and the first low density wet incinerator bottom ash such that the first high density wet incinerator bottom ash includes metallic solids (e.g., solids having specific gravity (SG) 3.0 or greater) and the first low density wet incinerator bottom ash includes solids that are likely not metallic (e.g., solids having a SG of less than 3.0). In some embodiments, a cutter of the pinched sluice acting as the first density separator 182 may be adjustable to vary a mass yield to concentrate. In some embodiments, the first density separator 182 may be configured to provide about a 13% mass yield to concentrate/heavy stream. For example, in some embodiments, the first high density wet incinerator bottom ash may be output at about 1 tonne/hour of solids and the first low density wet incinerator bottom ash may be output at about 7 tonnes/hour of solids.

In some embodiments, the first density separator 182 may be configured such that a first inefficiency ratio defined as a flow rate of low density solids in the first high density wet incinerator bottom ash over a total flow rate of solids in the first high density wet incinerator bottom ash is associated therewith. For example, in some embodiments, the first density separator 182 may be configured to separate metallic solids (e.g., solids having SG 3.0 or greater) into the first high density wet incinerator bottom ash and to separate non-metallic solids (e.g., solids having SG of less than 3.0) into the first low density wet incinerator bottom ash, but this separation may not be perfect and so the first high density wet incinerator bottom ash may include some low density solids having SG less than 3.0. For example, in some embodiments, the first high density wet incinerator bottom ash output by the first density separator may include a flow rate of 0.75 tonnes/hour of low density solids out of a total flow rate of solids of 1.0 tonnes/hour. In such embodiments, the inefficiency ratio of the first density separator may be about 75%.

In some embodiments, the first inefficiency ratio may be relatively high compared to an inefficiency ratio of the third density separator 186, for example, as discussed in further detail below. In various embodiments, this relatively high inefficiency ratio may allow the first density separator 182 to be made using a low cost device/system and/or such that it can handle a high flow rate.

In some embodiments, using the pinched sluice as the first density separator 182 may facilitate high capacity relative to cost albeit with a high inefficiency ratio, which may be acceptable for the first density separator 182 in accordance with various embodiments disclosed herein.

In various embodiments, the system 180 may include one or more flow controllers, such as, for example a pump and a set of pipes arranged to pump the first low density wet incinerator bottom ash to the second density separator 184.

The second density separator 184 may be configured to receive the first low density wet incinerator bottom ash and to separate by density from the first low density wet incinerator bottom ash, second high density wet incinerator bottom ash and second low density wet incinerator bottom ash. In various embodiments, the second density separator 184 may include one or more centrifugal concentrator density separators configured to separate the second high density wet incinerator bottom ash and the second low density wet incinerator bottom ash from the first low density wet incinerator bottom ash. The centrifugal concentrators may be configured to output the second high density wet incinerator bottom ash via a high density wet stream output 208 of the second density separator 184 and to output the second low density wet incinerator bottom ash via a low density wet stream output 210 of the second density separator 184. In some embodiments, for example, the second density separator 184 may include two centrifugal concentrators acting in parallel, such as two Falcon Concentrators by Sepro™, for example.

In some embodiments, the second density separator 184 may be configured to separate the second high density wet incinerator bottom ash and the second low density wet incinerator bottom ash such that the second high density wet incinerator bottom ash includes metallic solids (e.g., solids having specific gravity (SG) 3.0 or greater) and the second low density wet incinerator bottom ash includes solids that are likely not metallic (e.g., solids having a SG of less than 3.0). In some embodiments, the second density separator 184 may be configured to handle at its input, the flow rate of the first low density wet incinerator bottom ash and the third low density wet incinerator bottom ash (as described below), which may together include about 7.8 tonnes/hour of solids.

In some embodiments, the second density separator 184 may be configured to provide about a 0.64% mass yield to concentrate/heavy stream. For example, in some embodiments, the second high density wet incinerator bottom ash may be output at about 0.05 tonnes/hour of solids and the second low density wet incinerator bottom ash may be output at about 7.75 tonnes/hour of solids. In various embodiments, where a centrifugal concentrator is used, about 60-100 Gs may be applied to the incoming first low density wet incinerator bottom ash to facilitate separation.

In some embodiments, one or more centrifugal concentrators may be included in the second density separator because this type of density separator may facilitate high efficiency metal recovery at low selectivity ratios provided there is not too much metal in the input stream/feed. In some embodiments, use of the centrifugal concentrator may be advantageous after a pinched sluice because the pinched sluice removes most of the easy-to-recover metal and the centrifugal concentrator can be configured to focus on recovering/separating very fine metal particles that the pinched sluice is unable to selectively recover/separate.

In various embodiments, the second low density wet incinerator bottom ash may be discarded. In some embodiments, the output 210 of the second density separator may be in fluid communication with a refuse container which may be filled and periodically emptied at refuse site, such as a landfill, for example. In some embodiments, the second low density wet incinerator bottom ash may be dewatered using a filter press or dewatering centrifuge. The resulting dewatered product may then be sent to a landfill or may be used as construction material because the heavy material/metals have been removed.

In various embodiments, in the system 180, the second high density wet incinerator bottom ash may be the subject of further separation or processing, as will be discussed in further detail below.

Referring still to FIG. 2, the first high density wet incinerator bottom ash from the output 202 of the first density separator may flow to an input 212 of the third density separator 186. In various embodiments, the system 180 may include one or more flow controllers, such as, for example a set of pipes arranged such that gravity causes the first high density wet incinerator bottom ash to flow to the third density separator 186. In some embodiments, use of gravity flow control may be desirable to handle flow of high density and/or coarse particles included in the first high density wet incinerator bottom ash. In some embodiments, the flow controllers may also or alternatively include one or more pumps and/or a reservoir or pumpbox.

The third density separator 186 may be configured to receive the first high density wet incinerator bottom ash and to separate by density from the first high density wet incinerator bottom ash, third high density wet incinerator bottom ash and third low density wet incinerator bottom ash. In various embodiments, the third density separator 186 may include a shaking table, such as, for example, a Holman 8000 shaking table made by Holman-Wilfley, configured to separate the third high density wet incinerator bottom ash and the third low density wet incinerator bottom ash from the first high density wet incinerator bottom ash. The shaking table may be configured to output the third high density wet incinerator bottom ash via a high density wet stream output 214 of the third density separator 186 and to output the third low density wet incinerator bottom ash via a low density wet stream output 216 of the third density separator.

In some embodiments, the third density separator 186 may be configured to separate the third high density wet incinerator bottom ash and the third low density wet incinerator bottom ash such that the third high density wet incinerator bottom ash includes metallic solids (e.g., solids having specific gravity (SG) 3.0 or greater) and the third low density wet incinerator bottom ash includes solids that are likely not metallic (e.g., solids having a SG of less than 3.0). In some embodiments, the third density separator 186 may be configured to handle at its input 212, the flow rates of the first high density wet incinerator bottom ash and the second high density wet incinerator bottom ash, which may, for example include about 1 tonne/hour of solids. In some embodiments, the third density separator 186 may be configured such that the third high density wet incinerator bottom ash includes about 0.05 tonnes/hour of solids and the third low density wet incinerator bottom ash includes about 1.0 tonnes/hour of solids.

In some embodiments, use of the shaking table in the third density separator 186 may facilitate production of a clean metal concentrate, which contains very little low density waste material, in the third high density wet incinerator bottom ash. In some embodiments, the shaking table may be able to separate at a relatively low flow rate/capacity but may be usable as the third density separator 186 because the first density separator has already performed an initial separation which removes much of the low density material included in the input wet incinerator bottom ash such that only a low capacity is required of the third density separator.

In various embodiments, material from the third high density wet incinerator bottom ash may be recovered and/or stored. In some embodiments, the output 214 of the third density separator may be in fluid communication with the dewaterer 191 which may be configured to remove water from the wet incinerator bottom ash and to store the remaining material in a recovery container, which may be periodically emptied and/or sold. In some embodiments, the dewaterer 191 may include a box or container that is allowed to overflow and thus remove water via the overflow of water. In some embodiments, the dewaterer may include a fiber bag or filter for dewatering the third high density wet incinerator bottom ash.

In various embodiments, the system 180 may include one or more flow controllers, such as, for example a set of pipes arranged such that gravity causes the third high density wet incinerator bottom ash to flow to the dewaterer 191, for causing the dewaterer to remove water and recover metals from the third high density wet incinerator bottom ash.

In various embodiments, in the system 180, the third low density wet incinerator bottom ash from the output 216 of the third density separator 186 may be the subject of further processing, as will be discussed in further detail below.

In some embodiments, the third density separator 186 may be configured to have a third inefficiency ratio defined as a flow rate of low density solids in the third high density wet incinerator bottom ash over a total flow rate of solids in the third low density wet incinerator bottom ash. In some embodiments, the first density separator 182 may be configured to separate less efficiently than the third density separator 186. Accordingly, in some embodiments, the third inefficiency ratio of the third density separator 186 may be less than the first inefficiency ratio of the first density separator 182. In various embodiments, this difference in efficiency between the first and third density separators may facilitate fast, accurate and/or efficient separation and/or removal of high density material from incinerator bottom ash. For example, the first density separator 182 may process a large flow rate of incinerator bottom ash and remove a large flow rate of low density material, but may operate relatively inefficiently, allowing the third density separator 186 to be configured to focus on high efficiency in separating/processing of small flow rates of incinerator bottom ash.

In some embodiments, the first inefficiency ratio may be at least 5 times the third inefficiency ratio, and this may facilitate fast, accurate and/or efficient separation and/or removal of high density material from incinerator bottom ash. In some embodiments, for example, the first inefficiency ratio may be at least 35 times the third inefficiency ratio. For example, in some embodiments the third high density wet incinerator bottom ash output by the third density separator 186 may include a flow rate of 0.001 tonnes/hour of low density solids out of a total flow rate of solids of 0.05 tonnes/hour such that the third inefficiency ratio may be about 2%. In various embodiments, as discussed above, the first inefficiency ratio may be about 75% and so in various embodiments, the first inefficiency ratio may be about 37.5 times the third inefficiency ratio.

In some embodiments, using the shaking table as the third density separator 186 may facilitate the low inefficiency ratio that may be desired for the third density separator, since shaking tables may generally function well at low inefficiency ratios.

As discussed above, in various embodiments, further processing may be performed on the second high density wet incinerator bottom ash from the output 208 of the second density separator 184 shown in FIG. 2. In some embodiments, for example, the second high density wet incinerator bottom ash may be caused to flow to a second high density wet incinerator bottom ash density separator for causing the second high density wet incinerator bottom ash density separator to separate contents of the second high density wet incinerator bottom ash by density. This may facilitate further consideration and/or density separation processing for material that was first classified or separated as low density material by the first density separator 182 and then classified or separated as high density material by the second density separator 184. In various embodiments, this further processing may be helpful because material that has been classified as low density by the first density separator 182 and as high density by the second density separator 184 may have properties that make accurate and/or fast density separation difficult.

In some embodiments, the third density separator 186 may act as the second high density wet incinerator bottom ash density separator. In such embodiments, the system 180 may be configured to cause the second high density wet incinerator bottom ash to flow to the third density separator 186 for causing the third density separator to separate the contents of the second high density wet incinerator bottom ash by density.

For example, in some embodiments, the output 208 of the second density separator 184 may be in fluid communication with the input 212 of the third density separator 186 via a set of pipes and one or more pump and/or pumpbox or reservoir configured to cause the second high density wet incinerator bottom ash to flow from the output 208 of the second density separator 184 to the input 212 of the third density separator 186. The third density separator 186 may be configured to receive the second high density wet incinerator bottom ash and to separate the wet incinerator bottom ash by density.

In some embodiments, the input 212 of the third density separator 186 may receive a mixture of both the first high density wet incinerator bottom ash from the first density separator 182 and the second high density wet incinerator bottom ash from the second density separator 184, and the third density separator 186 may separate the third high density wet incinerator bottom ash and the third low density wet incinerator bottom ash from the received mixture. For example, in some embodiments, the system 180 may include a pumpbox or reservoir in fluid communication with the output 208 of the second density separator 184 and the output 202 of the first density separator 182. In operation, the pumpbox may be filled with the wet incinerator bottom ash from the outputs 202 and 208 and mixed, and a pump may cause the contents of the pumpbox to be flowed to the input 212 of the third density separator 186.

In some embodiments, using the third density separator 186 as the second high density wet incinerator bottom ash density separator may be desirable to allow further separation/processing of certain materials without incurring the cost of additional density separators in the system 180.

Referring still to FIG. 2, as discussed above, in various embodiments, the third low density wet incinerator bottom ash output by the output 216 of the third density separator 186 may be further processed. In some embodiments, for example, the third low density wet incinerator bottom ash may be caused to flow to a third low density wet incinerator bottom ash density separator for causing the third low density wet incinerator bottom ash density separator to separate contents of the third low density wet incinerator bottom ash by density. This may facilitate further consideration and/or density separation processing for material that was first classified or separated as high density material by the first density separator 182 and then classified or separated as low density material by the third density separator 186. In various embodiments, this further processing may be helpful because material that has been classified as high density by the first density separator 182 and as low density by the third density separator 186 may have properties that make accurate and/or fast density separation difficult, for example.

In some embodiments, the second density separator 184 may act as the third low density wet incinerator bottom ash density separator. In such embodiments, the system 180 may be configured to cause the third low density wet incinerator bottom ash to flow to the second density separator 184 for causing the second density separator to separate the contents of the third low density wet incinerator bottom ash by density.

For example, in some embodiments, the output 216 of the third density separator 186 may be in fluid communication with the input 206 of the second density separator 184 via a set of pipes and one or more pump configured to cause the third low density wet incinerator bottom ash to flow from the output 216 of the third density separator to the input 206 of the second density separator 184. The second density separator 184 may be configured to receive the third low density wet incinerator bottom ash and to separate the incinerator bottom ash by density.

In some embodiments, the input 206 of the second density separator 184 may receive a mixture of both the first low density wet incinerator bottom ash from the first density separator 182 and the third low density wet incinerator bottom ash from the third density separator 186, and the second density separator 184 may separate the second high density wet incinerator bottom ash and the second low density wet incinerator bottom ash from the received mixture. For example, in some embodiments, the system 180 may include a pumpbox or reservoir in fluid communication with the output 216 of the third density separator 186 and the output 204 of the first density separator 182. In operation, the pumpbox may be filled with the wet incinerator bottom ash from the outputs 204 and 216 and mixed, and a pump, such as a centrifugal pump, for example, may cause the contents of the pumpbox to be flowed to the input 206 of the second density separator 184.

In some embodiments, using the second density separator as the third low density wet stream density separator may be desirable to allow further separation without requiring the cost of additional density separators in the system.

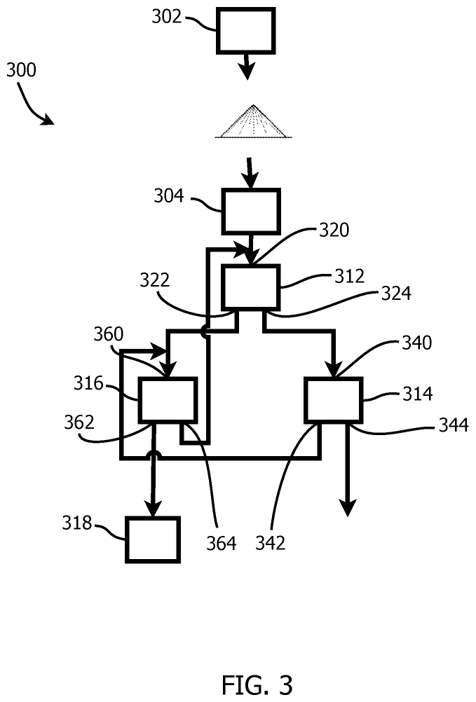

Referring now to FIG. 3, there is shown a system 300 for facilitating wet recovery of high density material from input wet incinerator bottom ash in accordance with various embodiments. In various embodiments, the system 300 may include elements generally similar to the elements of the system 180 shown in FIG. 2, for example.

Referring to FIG. 3, the system includes an incinerator 302, a wet incinerator bottom ash source 304, a first density separator 312, a second density separator 314, a third density separator 316, and a dewaterer 318, all of which may function generally similarly to the similarly named elements of the system 180 shown in FIG. 2. In various embodiments, the first density separator 312 includes an input 320, a high density wet stream output 322, and a low density wet stream output 324. The second density separator 314 includes an input 340 in fluid communication with the output 324 of the first density separator 312, a high density wet stream output 342, and a low density wet stream output 344. The third density separator 316 includes an input 360 in fluid communication with the output 322 of the first density separator 312 and may also include a high density wet stream output 362 and a low density wet stream output 364.

In various embodiments, the incinerator 302 and the wet incinerator bottom ash source 304 may function as described above having regard to the incinerator 188 and the wet incinerator bottom ash source 190 shown in FIG. 2, such that the wet incinerator bottom ash source 304 generates input wet incinerator bottom ash for reception by the first density separator 312. The first density separator 312 may be configured to receive the input wet incinerator bottom ash and separate by density from the input wet incinerator bottom ash, first high density wet incinerator bottom ash and first low density wet incinerator bottom ash. In some embodiments, in the system 300 shown in FIG. 3, the first density separator 312 may include a centrifugal concentrator, for example.

The second density separator 314 may be configured to receive the first low density wet incinerator bottom ash and to separate by density from the first low density wet incinerator bottom ash, second high density wet incinerator bottom ash and second low density wet incinerator bottom ash. In some embodiments, in the system 300 shown in FIG. 3, the second density separator 314 may include a pinched sluice, for example.

The third density separator 316 may be configured to receive the first high density wet incinerator bottom ash and to separate by density from the first high density wet incinerator bottom ash, third high density wet incinerator bottom ash and third low density wet incinerator bottom ash. In some embodiments, in the system 300 shown in FIG. 3, the third density separator 316 may include a shaking table, for example.

Referring to FIG. 3, in various embodiments, the output 342 of the second density separator 314 may be in fluid communication with the input 360 of the third density separator 316 via one or more flow controllers, such as a pump, pumpbox or reservoir, and pipes, configured to cause the second high density wet incinerator bottom ash to flow to the third density separator 316 for causing the third density separator to separate the contents of the second high density wet incinerator bottom ash by density. In various embodiments, the second high density wet incinerator bottom ash output by the second density separator 314 may be mixed in a pumpbox or reservoir, for example, with the first high density wet incinerator bottom ash before being pumped to and received by the third density separator 316.

Referring to FIG. 3, in various embodiments, the output 364 of the third density separator may be in fluid communication with the input 320 of the first density separator 312 via one or more flow controllers, such as a pump and pipes, configured to cause the third low density wet incinerator bottom ash to flow to the first density separator 312 for causing the first density separator to separate the contents of the third low density wet incinerator bottom ash by density. In such embodiments, the first density separator 312 may act as a third low density wet incinerator bottom ash density separator.

In various embodiments, the third low density wet incinerator bottom ash output by the third density separator 316 may be mixed in a pump box, for example, with the input wet incinerator bottom ash before being pumped to and received by the first density separator 312.

Accordingly, in some embodiments, the input 320 of the first density separator 312 may receive a mixture of both the input wet incinerator bottom ash and the third low density wet incinerator bottom ash, and the first density separator 312 may separate the first high density wet incinerator bottom ash and the first low density wet incinerator bottom ash from the received mixture. In some embodiments, using the first density separator 312 to further process the low density wet incinerator bottom ash output from the third density separator 316 may reduce the likelihood of losing or miscategorizing a high density material or metal since a high density particle incorrectly included in the third low density wet incinerator bottom ash by the third density separator 316 would have to pass through two density separators and be incorrectly separated at both, before being discarded.

### Various Embodiments

As discussed above, in some embodiments, the first high density wet incinerator bottom ash flowing from the output 122 of the first density separator 12 shown in FIG. 1 may be dewatered and the high density material and/or metals therein may be recovered, and in such embodiments, the third density separator 16 shown in FIG. 1 may be omitted from the system 10.

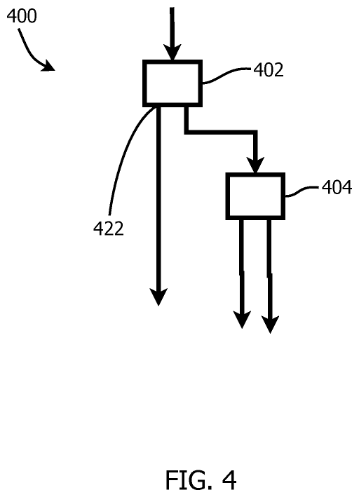

For example, referring to FIG. 4, there is shown a system 400 including elements generally similar to those included in the system 10 shown in FIG. 1, except that a third density separator is omitted. In various embodiments, the system 400 includes a first density separator 402 and a second density separator 404 which function generally similarly to the first and second density separators 12 and 14 shown in FIG. 1 and discussed above. Referring to FIG. 4, in the embodiment shown, the first density separator 402 includes a high density wet stream output 422 for outputting first high density wet incinerator bottom ash. In various embodiments, the output 422 may be in fluid communication with a dewaterer for removing water from the first high density wet incinerator bottom ash and recovering material therefrom. In various embodiments, in the system 400 shown in FIG. 4, the first density separator 402 may include a pinched sluice and the second density separator 404 may include a centrifugal concentrator. In various embodiments, in the arrangement shown in FIG. 4, use of the pinched sluice as the first density separator 402 and the centrifugal concentrator as the second density separator 404 may facilitate high flow rates, accurate separation of high density material, and/or low costs for separating such material from input wet incinerator bottom ash.

In various embodiments, features and/or elements of one or more of the systems 10, 180, 300, and 400 may be used with another one of the systems 10, 180, 300, and 400. For example, in various embodiments, the system 10 and/or the system 400 may further include an incinerator, a wet incinerator bottom ash source, and/or a dewaterer generally similar to the incinerator 188, wet incinerator bottom ash source 190 and dewaterer 191 included in the system 180 shown in FIG. 2. Further, in some embodiments, a system generally similar to the system 180 or the system 300 may omit the incinerator, wet incinerator bottom ash source, and/or dewaterer, and the functionality provided by these elements may be provided by another separate system and/or device.

In some embodiments additional or alternative density separators may be used and may act as any of the first, second, and/or third density separators described herein. For example, in various embodiments, any or all of the density separators described herein, including the first, second, and/or third density separators described herein, may include one or more of a pinched sluice, a shaking table, a centrifugal concentrator, a mineral jig, a spiral concentrator, a heavy media separation device, and/or another density or gravity separation device.

In some embodiments, additional or alternative separators may be included in the systems 10, 180, 300, and/or 400. For example, in some embodiments, the shaking table included in the third density separator 186 shown in FIG. 2 may include a magnetic separator for separating magnetic material from the input wet incinerator bottom ash. In some embodiments, the magnetic separator may include a belt magnet, for example.

In various embodiments alternative or additional flow controllers to those discussed above may be used. For example, in some embodiments, any or all of the flow controllers described herein may include a set of pipes, which may be arranged such that gravity causes the desired flow, one or more pumps (which may include peristaltic and/or centrifugal pumps, for example), and/or one or more pumpboxes or reservoirs for collecting fluid to be pumped.

In some embodiments, the second high density wet incinerator bottom ash density separator and/or the third high density wet incinerator bottom ash density separator may be implemented as additional separate density separators compared to the density separators shown in FIGS. 2 and/or 3.

While specific embodiments of the invention have been described and illustrated, such embodiments should be considered illustrative of the invention only and not as limiting the invention as construed in accordance with the accompanying claims.

1. A method of facilitating wet recovery of high density material from input wet incinerator bottom ash, the method comprising:
receiving the input wet incinerator bottom ash at a first density separator;
separating by density from the input wet incinerator bottom ash, by the first density separator, first high density wet incinerator bottom ash and first low density wet incinerator bottom ash;
causing the first low density wet incinerator bottom ash to flow to a second density separator; and
separating by density from the first low density wet incinerator bottom ash, by the second density separator, second high density wet incinerator bottom ash and second low density wet incinerator bottom ash.

2. The method of claim 1, further comprising
causing the first high density wet incinerator bottom ash to flow to a third density separator; and
separating by density from the first high density wet incinerator bottom ash, by the third density separator, third high density wet incinerator bottom ash and third low density wet incinerator bottom ash.

3. The method of claim 2, further comprising causing the second high density wet incinerator bottom ash to flow to a second high density wet incinerator bottom ash density separator for causing the second high density wet incinerator bottom ash density separator to separate contents of the second high density wet incinerator bottom ash by density.

4. The method of claim 3, wherein the third density separator acts as the second high density wet incinerator bottom ash density separator and wherein causing the second high density wet incinerator bottom ash to flow to the second high density wet incinerator bottom ash density separator comprises causing the second high density wet incinerator bottom ash to flow to the third density separator for causing the third density separator to separate the contents of the second high density wet incinerator bottom ash by density.

5. The method of claim 2, further comprising causing the third low density wet incinerator bottom ash to flow to a third low density wet incinerator bottom ash density separator for causing the third low density wet incinerator bottom ash density separator to separate contents of the third low density wet incinerator bottom ash by density.

6. The method of claim 5, wherein the second density separator acts as the third low density wet incinerator bottom ash density separator and wherein causing the third low density wet incinerator bottom ash to flow to the third low density wet incinerator bottom ash density separator comprises causing the third low density wet incinerator bottom ash to flow to the second density separator for causing the second density separator to separate the contents of the third low density wet incinerator bottom ash by density.

7. The method of claim 5, wherein the first density separator acts as the third low density wet incinerator bottom ash density separator and wherein causing the third low density wet incinerator bottom ash to flow to the third low density wet incinerator bottom ash density separator comprises causing the third low density wet incinerator bottom ash to flow to the first density separator for causing the first density separator to separate the contents of the third low density wet incinerator bottom ash by density.

8. The method of claim 2, further comprising causing the third high density wet incinerator bottom ash to flow to a dewaterer for causing the dewaterer to remove water and recover metals from the third high density wet incinerator bottom ash.

9. The method of claim 2, wherein the first density separator separates less efficiently than the third density separator separates such that a first inefficiency ratio of a flow rate of low density solids in the first high density wet incinerator bottom ash over a total flow rate of solids in the first high density wet incinerator bottom ash is greater than a third inefficiency ratio of a flow rate of low density solids in the third high density wet incinerator bottom ash over a total flow rate of solids in the third low density wet incinerator bottom ash.

10. The method of claim 9, wherein the first inefficiency ratio is at least 5 times the third inefficiency ratio.

11. The method of claim 2, wherein the third density separator comprises a shaking table and wherein separating the third high density wet incinerator bottom ash and the third low density wet incinerator bottom ash from the first high density wet incinerator bottom ash comprises separating using the shaking table.

12. The method of claim 1, wherein the first density separator comprises a pinched sluice density separator and wherein separating the first high density wet incinerator bottom ash and the first low density wet incinerator bottom ash from the input wet incinerator bottom ash comprises separating using the pinched sluice density separator.

13. The method of claim 1, wherein the second density separator comprises a centrifugal concentrator and wherein separating the second high density wet incinerator bottom ash and the second low density wet incinerator bottom ash from the first low density wet incinerator bottom ash comprises separating using the centrifugal concentrator.

14. The method of claim 1, wherein receiving the input wet incinerator bottom ash comprises receiving the input wet incinerator bottom ash consisting of a suspension of fine incinerator bottom ash in liquid, the fine incinerator bottom ash consisting of particles having a maximum diameter of less than a threshold diameter of about 4 mm.

15. The method of claim 1, further comprising generating the input wet incinerator bottom ash from source incinerator bottom ash.

16. The method of claim 15, further comprising incinerating input material to generate the source incinerator bottom ash.

17. A system for facilitating wet recovery of high density material from input wet incinerator bottom ash, the system comprising:
a first density separator configured to receive the input wet incinerator bottom ash and separate by density from the input wet incinerator bottom ash, first high density wet incinerator bottom ash and first low density wet incinerator bottom ash; and
a second density separator configured to receive the first low density wet incinerator bottom ash and to separate by density from the first low density wet incinerator bottom ash, second high density wet incinerator bottom ash and second low density wet incinerator bottom ash.

18. The system of claim 17, further comprising:
a third density separator configured to receive the first high density wet incinerator bottom ash and to separate by density from the first high density wet incinerator bottom ash, third high density wet incinerator bottom ash and third low density wet incinerator bottom ash.

19. The system of claim 18, further comprising a second high density wet incinerator bottom ash density separator configured to receive the second high density wet incinerator bottom ash and to separate contents of the second high density wet incinerator bottom ash by density.

20. The system of claim 19, wherein the third density separator acts as the second high density wet incinerator bottom ash density separator and wherein the third density separator is configured to receive the second high density wet incinerator bottom ash and to separate contents of the second high density wet incinerator bottom ash by density.

21. The system of claim 18, further comprising a third low density wet incinerator bottom ash density separator configured to receive the third low density wet incinerator bottom ash and to separate contents of the third low density wet incinerator bottom ash by density.

22. The system of claim 21, wherein the second density separator acts as the third low density wet incinerator bottom ash density separator and wherein the second density separator is configured to receive the third low density wet incinerator bottom ash and to separate the contents of the third low density wet incinerator bottom ash by density.

23. The system of claim 21, wherein the first density separator acts as the third low density wet incinerator bottom ash density separator and wherein the first density separator is configured to receive the third low density wet incinerator bottom ash and to separate the contents of the third low density wet incinerator bottom ash by density.

24. The system of claim 18, further comprising a dewaterer configured to remove water and recover metals from the third high density wet incinerator bottom ash.

25. The system of claim 18, wherein the first density separator is configured to separate less efficiently than the third density separator separates such that a first inefficiency ratio of a flow rate of low density solids in the first high density wet incinerator bottom ash over a total flow rate of solids in the first high density wet incinerator bottom ash is greater than a third inefficiency ratio of a flow rate of low density solids in the third high density wet incinerator bottom ash over a total flow rate of solids in the third low density wet incinerator bottom ash.

26. The system of claim 25, wherein the first inefficiency ratio is at least 5 times the third inefficiency ratio.

27. The system of claim 18, wherein the third density separator comprises a shaking table.

28. The system of claim 17, wherein the first density separator comprises a pinched sluice density separator.

29. The system of claim 17, wherein the second density separator comprises a centrifugal concentrator.

30. The system of claim 17, wherein the input wet incinerator bottom ash consists of a suspension of fine incinerator bottom ash in liquid, the fine incinerator bottom ash consisting of particles having a maximum diameter of less than a threshold diameter of about 4 mm.

31. The system of claim 17, further comprising a wet incinerator bottom ash source configured to generate the input wet incinerator bottom ash from source incinerator bottom ash.

32. The system of claim 31, further comprising an incinerator configured to incinerate input material to generate the source incinerator bottom ash.
